(19) United States
(12) Patent Application Publication
(10) Pub. No.: US 2023/0099635 A1
(43) Pub. Date: Mar. 30, 2023

(54) CONTEXT AWARE AUTOMATED ARTIFICIAL INTELLIGENCE FRAMEWORK

(71) Applicant: INTERNATIONAL BUSINESS MACHINES CORPORATION, ARMONK, NY (US)

(72) Inventors: SHIKHAR KWATRA, SAN JOSE, CA (US); SOURAV MAZUMDER, CONTRA COSTA, CA (US); INDERVIR SINGH BANIPAL, AUSTIN, TX (US); AARON K. BAUGHMAN, CARY, NC (US)

(21) Appl. No.: 17/449,111

(22) Filed: Sep. 28, 2021

(51) Int. Cl. G06N 5/02

(52) U.S. Cl. CPC G06N 5/022

(57) ABSTRACT

A method, system, and computer program product for context-based machine learning model generation are provided. The method collects ground data for a set of machine learning model deployments associated with a set of problems. A knowledge graph is generated for the set of machine learning models based on the ground data. An initial set of hyperparameters are determined for a new problem based on the knowledge graph. A modified set of hyperparameters are generated for the new problem based on the initial set of hyperparameters. The method generates a machine learning model for the new problem based on the modified set of hyperparameters.

### BACKGROUND

Current artificial intelligence (AI) frameworks perform a variety of data science tasks. Some AI frameworks perform extract-transform-load (ETL) operations. Some AI frameworks perform machine learning model functions. Some AI frameworks train and tune parameters across machine learning pipelines after a user assigns target variables.

### SUMMARY

According to an embodiment described herein, a computer-implemented method for context-based machine learning model generation is provided. The method collects ground data for a set of machine learning model deployments associated with a set of problems. A knowledge graph is generated for the set of machine learning models based on the ground data. An initial set of hyperparameters are determined for a new problem based on the knowledge graph. A modified set of hyperparameters are generated for the new problem based on the initial set of hyperparameters. The method generates a machine learning model for the new problem based on the modified set of s.

According to an embodiment described herein, a system for context-based machine learning model generation is provided. The system includes one or more processors and a computer-readable storage medium, coupled to the one or more processors, storing program instructions that, when executed by the one or more processors, cause the one or more processors to perform operations. The operations collect ground data for a set of machine learning model deployments associated with a set of problems. A knowledge graph is generated for the set of machine learning models based on the ground data. An initial set of hyper-parameters are determined for a new problem based on the knowledge graph. A modified set of hyper-parameters are generated for the new problem based on the initial set of hyper-parameters. The operations generate a machine learning model for the new problem based on the modified set of hyper-parameters.

According to an embodiment described herein, a computer program product for context-based machine learning model generation is provided. The computer program product includes a computer-readable storage medium having program instructions embodied therewith, the program instructions being executable by one or more processors to cause the one or more processors to collect ground data for a set of machine learning model deployments associated with a set of problems. A knowledge graph is generated for the set of machine learning models based on the ground data. An initial set of hyper-parameters are determined for a new problem based on the knowledge graph. A modified set of hyper-parameters are generated for the new problem based on the initial set of hyper-parameters. The computer program product generates a machine learning model for the new problem based on the modified set of hyper-parameters.

### BRIEF DESCRIPTION OF THE DRAWINGS

FIG. 1 depicts a block diagram of a computing environment for implementing concepts and computer-based methods, according to at least one embodiment.

FIG. 2 depicts a flow diagram of a computer-implemented method for context-based machine learning model generation, according to at least one embodiment.

FIG. 3 depicts a block diagram of a computing system for context-based machine learning model generation, according to at least one embodiment.

FIG. 4 is a schematic diagram of a cloud computing environment in which concepts of the present disclosure may be implemented, in accordance with an embodiment of the present disclosure.

FIG. 5 is a diagram of model layers of a cloud computing environment in which concepts of the present disclosure may be implemented, in accordance with an embodiment of the present disclosure.

### DETAILED DESCRIPTION

The present disclosure relates generally to methods for context-based machine learning model generation. More particularly, but not exclusively, embodiments of the present disclosure relate to a computer-implemented method for linking use case context for generating machine learning models. The present disclosure relates further to a related system for context-based machine learning model generation, and a computer program product for operating such a system.

Current AI frameworks perform a variety of data science tasks. AI frameworks may perform complex tasks such as ETL to model selection, training and hyper tuning parameters across a pipeline to optimize accuracy or performance metrics. These AI frameworks may perform such operations once a user has assigned target variables in need of optimization. Where some current AI frameworks are considered to address a problem using convolutional neural networks (CNN), a pipeline for problem solving involves performing data transformations such as taking average or maximums of strides without knowledge of a use case. In such cases, the AI framework may use radial basis function (RBF) optimization and a data allocation upper bound (DAUB) algorithm. The AI framework may also use reinforcement learning to generate a machine learning model for later optimization. Such models may be considered a local optimum generated for additional tuning or modification. However, current AI frameworks lack an ability to develop context-based machine learning models. For example, Current AI frameworks do not link context with respect to use cases to be solved or addressed by a machine learning model.

Embodiments of the present disclosure describe context aware AI frameworks. Some embodiments of the present disclosure enable linkage of context with respect to use cases to be addressed by machine learning models. Embodiments of the present disclosure describe AI frameworks which pre-process knowledge extracted from previously generated machine learning models to gather information about a current problem to be addressed by a machine learning model to be generated by the AI frameworks. Some embodiments of the present disclosure describe an AI framework which links a problem to a use case to incorporate heuristic information into an AI enabling platform. Some embodiments of the present disclosure describe mapping problems to be addressed by machine learning models to taxonomies to allow for use of a knowledge base developed from previous machine learning models and problems. Some embodiments of the present disclosure leverage the context aware development of machine learning models and knowledge of hyper-parameters, described above, to accelerate a pipeline for machine learning model creation to deployment.

Some embodiments of the concepts described herein may take the form of a system or a computer program product. For example, a computer program product may store program instructions that, when executed by one or more processors of a computing system, cause the computing system to perform operations described above with respect to the computer-implemented method. By way of further example, the system may comprise components, such as processors and computer-readable storage media. The computer-readable storage media may interact with other components of the system to cause the system to execute program instructions comprising operations of the computer-implemented method, described herein. For the purpose of this description, a computer-usable or computer-readable medium may be any apparatus that may contain means for storing, communicating, propagating, or transporting the program for use, by, or in connection with, the instruction execution system, apparatus, or device.

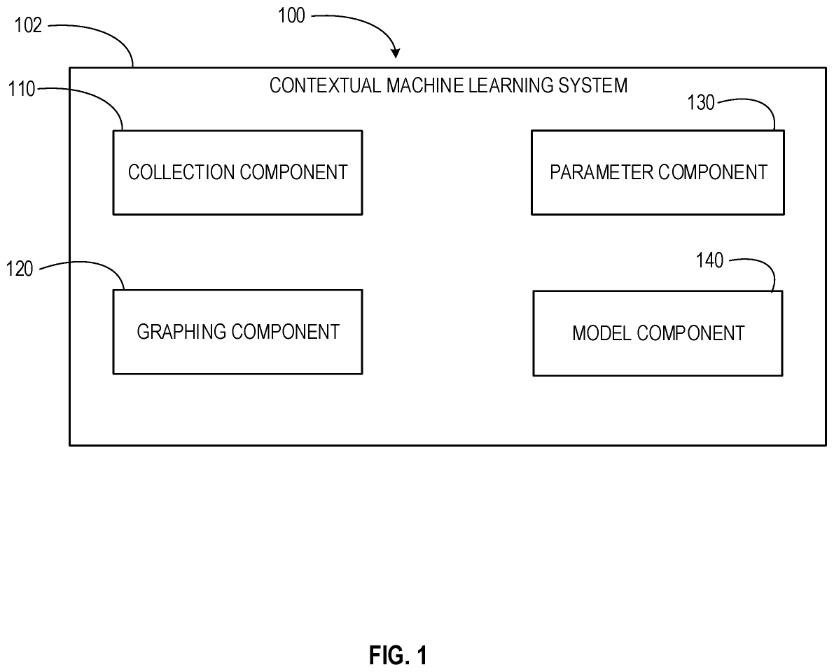

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may include a contextual machine learning system 102. The contextual machine learning system 102 may comprise a collection component 110, a graphing component 120, a parameter component 130, and a model component 140. The collection component 110 collects ground data for machine learning model deployments. The graphing component 120 generates knowledge graphs for sets of machine learning models based on collected ground data. The parameter component 130 determines initial hyper-parameters and modified hyper-parameters based on knowledge graphs and problem taxonomies. The model component 140 generates machine learning models based on modified hyper-parameters. Although described with distinct components, it should be understood that, in at least some embodiments, components may be combined or divided, and/or additional components may be added without departing from the scope of the present disclosure.

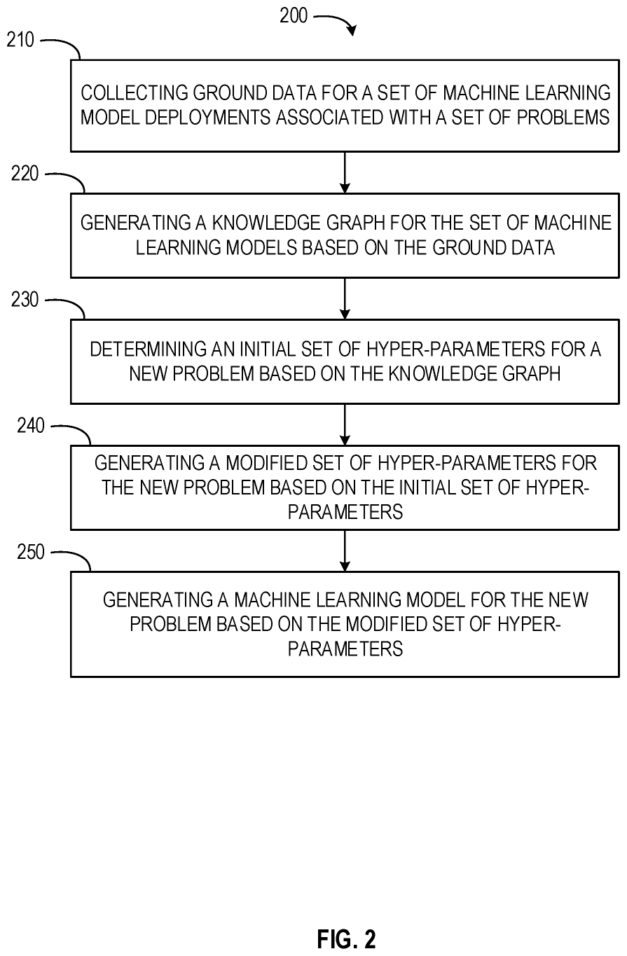

Referring now to FIG. 2, a flow diagram of a computer-implemented method 200 is shown. The computer-implemented method 200 is a method for context-based machine learning model generation. In some embodiments, the computer-implemented method 200 may be performed by one or more components of the computing environment 100, as described in more detail below.

At operation 210, the collection component 110 collects ground data for a set of machine learning model deployments. The ground data may include hyper-parameters used in deployed machine learning models, a taxonomy of a problem to be addressed by a deployed machine learning model, a domain of a problem, keywords, problem statements, combinations thereof, or any other suitable data which can be collected from deployed machine learning models. The ground data may be data collected pertaining to historical machine learning model deployments and problems solved by those historical machine learning models. The ground data may be collected when a machine learning model is run or deployed.

In some embodiments, the set of machine learning model deployments are associated with a set of problems. The ground data may include a set of historic hyper-parameters used by the set of machine learning models. In some instances, set of machine learning model deployments, the set of problems, and the set of historic hyper-parameters are associated with keywords. The keywords may be selected to described aspects, characteristics, classifications, or categories of one or more of the machine learning model deployments, the problems, and the historic hyper-parameters. The keywords may be encoded in a numerical format by assigning a value to each keyword.

The ground data may act as a baseline for contextual generation of machine learning models. In some instances, the baseline is a set of hyper-parameters with a context of a type of machine learning model associated with the set of hyper-parameters and a context of a problem or type of problem being addressed by the machine learning model and the set of hyper-parameters. The baseline may then be acted upon, changed, or modified based on a new problem to be addressed.

For example, a problem to be addressed may be cancer classification based on a set of images as a data set. CNN algorithms and learning parameters, such as a kernel and strides, may be used to address the classification problem. In such an example, instead of starting from scratch and fine-tuning a kernel and strides with fixed values and iterations over multiple cycles, the parameters may be kept as variables, such as Strides=$strides, Kernel=#Conv2D filter [K*K], dilation=N. Previous CNN algorithms and parameters, used for different or similar classification operations, may be used as the baseline for the collected ground data.

At operation 220, the graphing component 120 generates a knowledge graph for the set of machine learning models. In some embodiments, the knowledge graph is generated based on the ground data collected for the set of machine learning model deployments. In some instances, the knowledge graph is generated based on keywords associated with one or more of the set of machine learning models, the set of hyperparameters, and the set of problems.

In some instances, the knowledge graph is generated as a taxonomy for the ground data and the set of problems. The taxonomy may be constructed using keywords associated with one or more of the set of machine learning models, the set of hyperparameters, and the set of problems. In some instances, the taxonomy may be generated based on a classification of each problem of the set of problems. The classification of each problem may be included in the keywords.

In some embodiments, the knowledge graph is processed to generate a modified knowledge graph. In some instances, the modified knowledge graph may be a modified taxonomy. The modified knowledge graph may be generated using cross domain knowledge transfer. In some instances, the modified knowledge graph is generated using cross domain knowledge transfer using structured representations. Cross domain knowledge transfer may be performed by determining a structure of a task or problem using a set of neural networks. Determining similar tasks and similar solutions associated with those tasks. The similar tasks and similar solutions may then be mapped, such that parts or layers of a machine learning model associated with those tasks or solutions may be reorganized to address additional tasks to provide new solutions to the additional tasks.

At operation 230, the parameter component 130 determines an initial set of hyperparameters. The initial set of hyperparameters may be determined for a new problem. In some embodiments, the initial set of hyperparameters are determined based on the knowledge graph. The parameter component 130 may predict the hyperparameters based on a similarity of the new problem to one or more problems of the set of problems. In some instances, the parameter component 130 predicts the hyperparameters for inclusion in the initial set of hyperparameters by selecting hyperparameters or parameters associated with a specified domain or taxonomy for one or more problems of the set of problems which correspond to the new problem. Similar hyperparameter vectors may be grouped together to be made more generic to avoid overfitting using hierarchical clustering as described herein.

In some embodiments, the initial set of hyperparameters are determined by performing hierarchical clustering. The hierarchical clustering may be performed to match one or more aspects of the new problem to hyperparameters of one or more similar problems of the set of problems. In some embodiments, the one or more aspects are matched based on similar hyperparameters and similar taxonomy category.

At operation 240, the parameter component 130 generates a modified set of hyperparameters. The modified set of hyperparameters are generated for the new problem. In some embodiments, the modified set of hyperparameters are generated based on the initial set of hyperparameters. The modified set of hyperparameters may be an optimized or theoretically optimized set of hyperparameters derived from the initial set of hyperparameters. In some instances, the modified set of hyperparameters are one or more selected subsets of hyperparameters selected from the initial set of hyperparameters based on parameter variations configured to tune the initial set of hyperparameters to accurately address the new problem based on the classification of the new problem using the knowledge graph or taxonomy.

In some embodiments, the modified set of hyperparameters are generated by performing reinforcement learning. The reinforcement learning may be performed on the initial set of hyperparameters. In some instances, the reinforcement learning is performed on the initial set of hyperparameters against the hyperparameters of one or more similar problems. Performing reinforcement learning of the initial set of hyperparameters against the hyperparameters of the one or more similar problems may identify the set of modified hyperparameters. In some embodiments, the set of modified hyperparameters are identified as a subset of the initial set of hyperparameters which are selected based on convergence or divergence operations and tuned to address the new problem. The reinforcement learning may use a training set of the hyperparameters (e.g., the initial set of hyperparameters) pit against existing hyperparameters against corresponding domain/taxonomy to generate/validate the modified set of hyperparameters as an optimal or theoretically optimal set of hyperparameters. In some embodiments, the parameter component 130 uses neural network architecture search with reinforcement learning to learn a series of hyperparameters and places of which to transfer knowledge into the neural network. In some instances, the parameter component 130 uses recurrent neural networking that learns over time which hyperparameters to use for candidate neural networks. Further, the parameter component 130 may learn dilation and levels of which to insert domain knowledge into a candidate neural network.

In some embodiments, the modified set of hyperparameters may be generated by selecting between parameters which have fixed values and parameters which are variable. In such instances, the parameter component 130 may change parameters to change the modified set of hyperparameters. In some instances, the parameter component 130 changes parameters by changing keywords using cosine similarity to convert a numerically formatted keyword to a stride value. The parameter component 130 may then use an average value of keywords do determine parameters to be included in the modified set of hyperparameters.

In some embodiments, the parameter component 130 generates the modified set of hyperparameters using hierarchical clustering or hierarchical cluster analysis. In such embodiments, the parameter component 130 groups similar parameters into clusters. Each cluster of parameters may be distinct from other clusters and the parameters within each cluster may be broadly similar to each other. Parameters in a cluster may be more similar to other parameters in the cluster than to parameters in other clusters. The parameter component 130 may perform hierarchical clustering using the taxonomy to generate domain based hierarchical clustered domains. The hierarchical clustered domains may be accumulated to cluster data points which have similar hyperparameters and similar domains/taxonomy against the hyperparameters.

In the example of cancer classification, a CNN may be selected and rounded with the stride to provide modified hyperparameters. The values for the hyperparameters may be based on the taxonomy created on classification of a problem statement for the cancer classification in conjunction with information extracted from the knowledge graph and ground data. In some instances, the values of the hyperparameters are based on the taxonomy and information extracted from a knowledge base or web crawler systems.

At operation 250, the model component 140 generates a machine learning model for the new problem. In some embodiments, the machine learning model is generated based on the modified set of hyperparameters. The machine learning model may be created with fixed value parameters in the modified set of hyperparameters and at least one variable parameter.

In some embodiments, a representation of the new problem is learned and encoded in a single layer neural network of the machine learning model. In such embodiments, many single layer neural networks can learn about different representation points of the problem. Each of the single neural networks can be lased within a deep learning algorithm during back propagation such that the deep neural network learns to solve or address the new problem with the context knowledge about a corpus. In some instances, a neural network architecture search (NNAS) determines places within the machine learning model to interlace or transfer the knowledge from several neural networks into the deep neural network.

In the example of cancer classification, the model component 140 initiates creation of a new machine learning model for collecting experience, knowledge, crowdsourced data, and taxonomy classifications for aiding in the cancer classification problem. In some instances, a user may define an end user interface and specify a set of keywords as a basis for creation of the machine learning model and selection of the initial set of hyperparameters and the modified set of hyperparameters.

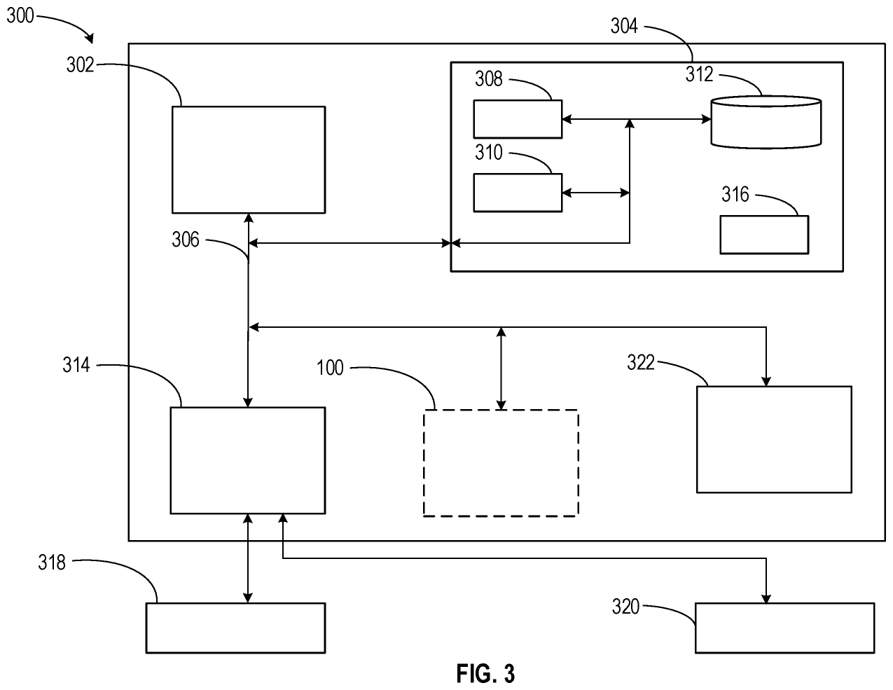

Embodiments of the present disclosure may be implemented together with virtually any type of computer, regardless of the platform is suitable for storing and/or executing program code. FIG. 3 shows, as an example, a computing system 300 (e.g., cloud computing system) suitable for executing program code related to the methods disclosed herein and for context-based machine learning model generation.

The computing system 300 is only one example of a suitable computer system and is not intended to suggest any limitation as to the scope of use or functionality of embodiments of the present disclosure described herein, regardless, whether the computer system 300 is capable of being implemented and/or performing any of the functionality set forth hereinabove. In the computer system 300, there are components, which are operational with numerous other general purpose or special purpose computing system environments or configurations. Examples of well-known computing systems, environments, and/or configurations that may be suitable for use with computer system/server 300 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like. Computer system/server 300 may be described in the general context of computer system-executable instructions, such as program modules, being executed by a computer system 300. Generally, program modules may include routines, programs, objects, components, logic, data structures, and so on that perform particular tasks or implement particular abstract data types. Computer system/server 300 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 300 is shown in the form of a general-purpose computing device. The components of computer system/server 300 may include, but are not limited to, one or more processors 302 (e.g., processing units), a system memory 304 (e.g., a computer-readable storage medium coupled to the one or more processors), and a bus 306 that couple various system components including system memory 304 to the processor 302. Bus 306 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 300 typically includes a variety of computer system readable media. Such media may be any available media that is accessible by computer system/server 300, and it includes both, volatile and non-volatile media, removable and non-removable media.

The system memory 304 may include computer system readable media in the form of volatile memory, such as random-access memory (RAM) 308 and/or cache memory 310. Computer system/server 300 may further include other removable/non-removable, volatile/non-volatile computer system storage media. By way of example only, a storage system 312 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 306 by one or more data media interfaces. As will be further depicted and described below, the system memory 304 may include at least one program product having a set (e.g., at least one) of program modules that are configured to carry out the functions of embodiments of the present disclosure.

The program/utility, having a set (at least one) of program modules 316, may be stored in the system memory 304 by way of example, and not limiting, as well as an operating system, one or more application programs, other program modules, and program data. Program modules may include one or more of the collection component 110, the graphing component 120, the parameter component 130, and the model component 140, which are illustrated in FIG. 1. Each of the operating systems, one or more application programs, other program modules, and program data or some combination thereof, may include an implementation of a networking environment. Program modules 316 generally carry out the functions and/or methodologies of embodiments of the present disclosure, as described herein.

The computer system/server 300 may also communicate with one or more external devices 318 such as a keyboard, a pointing device, a display 320, etc.; one or more devices that enable a user to interact with computer system/server 300; and/or any devices (e.g., network card, modem, etc.) that enable computer system/server 300 to communicate with one or more other computing devices. Such communication can occur via Input/Output (I/O) interfaces 314. Still yet, computer system/server 300 may communicate with one or more networks such as a local area network (LAN), a general wide area network (WAN), and/or a public network (e.g., the Internet) via network adapter 322. As depicted, network adapter 322 may communicate with the other components of computer system/server 300 via bus 306. It should be understood that, although not shown, other hardware and/or software components could be used in conjunction with computer system/server 300. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models may include private cloud, community cloud, public cloud, and hybrid cloud. In private cloud, the cloud infrastructure is operated solely for an organization. It may be managed by the organization or a third party and may exist on-premises or off-premises. In community cloud, the cloud infrastructure is shared by several organizations and supports specific community that has shared concerns (e.g., mission, security requirements, policy, and compliance considerations). It may be managed by the organizations or a third party that may exist on-premises or off-premises. In public cloud, the cloud infrastructure is made available to the general public or a large industry group and is owned by an organization selling cloud services. In hybrid cloud, the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling modularity, and semantic interoperability. At the heart of cloud computing is an infrastructure that includes a network of interconnected nodes.

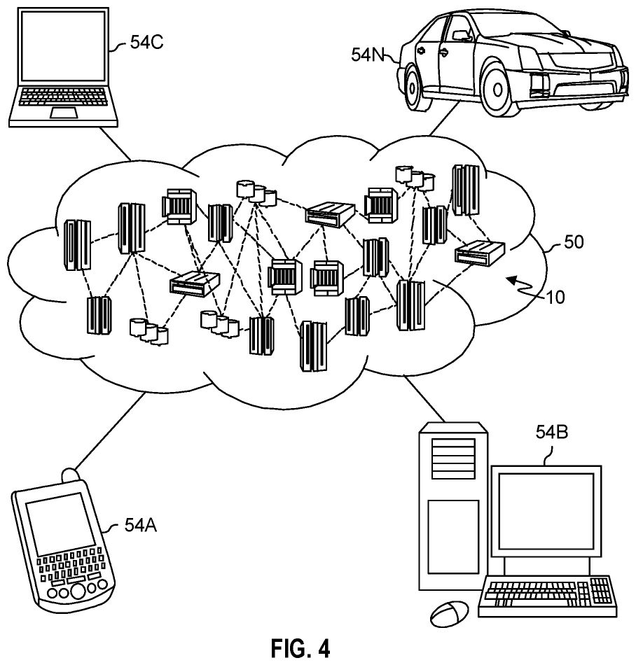

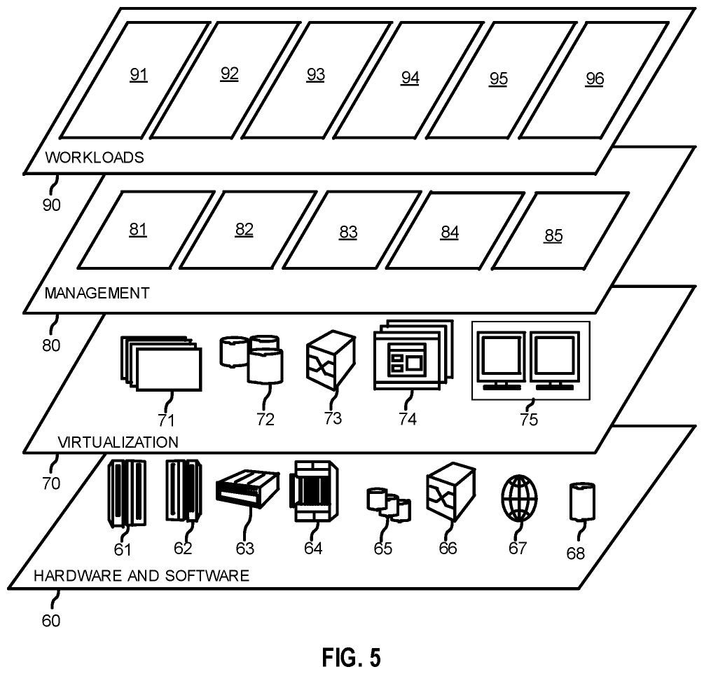

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and contextual machine learning processing 96.

Cloud models may include characteristics including on-demand self-service, broad network access, resource pooling, rapid elasticity, and measured service. In on-demand self-service a cloud consumer may unilaterally provision computing capabilities such as server time and network storage, as needed automatically without requiring human interaction with the service's provider. In broad network access, capabilities are available over a network and accessed through standard mechanisms that promote use by heterogeneous thin or thick client platforms (e.g., mobile phones, laptops, and PDAs). In resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In rapid elasticity, capabilities can be rapidly and elastically provisioned, in some cases automatically, to quickly scale out and rapidly released to quickly scale in. To the consumer, the capabilities available for provisioning often appear to be unlimited and can be purchased in any quantity at any time. In measured service, cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer-readable storage medium (or media) having computer readable program instructions thereon for causing a processor to carry out aspects of the present invention.

The computer-readable storage medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting ground data for a set of machine learning model deployments associated with a set of problems;
generating a knowledge graph for the set of machine learning models based on the ground data;
determining an initial set of hyperparameters for a new problem based on the knowledge graph;
generating a modified set of hyperparameters for the new problem based on the initial set of hyperparameters; and
generating a machine learning model for the new problem based on the modified set of hyperparameters.

2. The method of claim 1, wherein the ground data includes a set of historic hyperparameters used by the set of machine learning models.

3. The method of claim 1, wherein the knowledge graph is a taxonomy for the ground data and the set of problems.

4. The method of claim 3, wherein the taxonomy is generated based on a classification of each problem of the set of problems.

5. The method of claim 3, wherein determining the initial set of hyperparameters further comprises:
performing hierarchical clustering to match one or more aspects of the new problem to hyperparameters of one or more similar problems of the set of problems.

6. The method of claim 5, wherein generating the modified set of hyperparameters further comprises:
performing reinforcement learning on the initial set of hyperparameters against the hyperparameters of the one or more similar problems to identify the set of modified hyperparameters.

7. The method of claim 5, wherein the one or more aspects are matched based on similar hyperparameters and similar taxonomy category.

8. A system, comprising:
one or more processors; and
a computer-readable storage medium, coupled to the one or more processors, storing program instructions that, when executed by the one or more processors, cause the one or more processors to perform operations comprising:
collecting ground data for a set of machine learning model deployments associated with a set of problems;
generating a knowledge graph for the set of machine learning models based on the ground data;
determining an initial set of hyperparameters for a new problem based on the knowledge graph;
generating a modified set of hyperparameters for the new problem based on the initial set of hyperparameters; and
generating a machine learning model for the new problem based on the modified set of hyperparameters.

9. The system of claim 8, wherein the ground data includes a set of historic hyperparameters used by the set of machine learning models.

10. The system of claim 8, wherein the knowledge graph is a taxonomy for the ground data and the set of problems.

11. The system of claim 10, wherein the taxonomy is generated based on a classification of each problem of the set of problems.

12. The system of claim 10, wherein determining the initial set of hyperparameters further comprises:
performing hierarchical clustering to match one or more aspects of the new problem to hyperparameters of one or more similar problems of the set of problems.

13. The system of claim 12, wherein generating the modified set of hyperparameters further comprises:
performing reinforcement learning on the initial set of hyperparameters against the hyperparameters of the one or more similar problems to identify the set of modified hyperparameters.

14. The system of claim 12, wherein the one or more aspects are matched based on similar hyperparameters and similar taxonomy category.

15. A computer program product comprising a computer readable storage medium having program instructions embodied therewith, the program instructions being executable by one or more processors to cause the one or more processors to perform operations comprising:
collecting ground data for a set of machine learning model deployments associated with a set of problems;
generating a knowledge graph for the set of machine learning models based on the ground data;
determining an initial set of hyperparameters for a new problem based on the knowledge graph;
generating a modified set of hyperparameters for the new problem based on the initial set of hyperparameters; and
generating a machine learning model for the new problem based on the modified set of hyperparameters.

16. The computer program product of claim 15, wherein the ground data includes a set of historic hyperparameters used by the set of machine learning models.

17. The computer program product of claim 15, wherein the knowledge graph is a taxonomy for the ground data and the set of problems and the taxonomy is generated based on a classification of each problem of the set of problems.

18. The computer program product of claim 17, wherein determining the initial set of hyperparameters further comprises:
performing hierarchical clustering to match one or more aspects of the new problem to hyperparameters of one or more similar problems of the set of problems.

19. The computer program product of claim 18, wherein generating the modified set of hyperparameters further comprises:
performing reinforcement learning on the initial set of hyperparameters against the hyperparameters of the one or more similar problems to identify the set of modified hyperparameters.

20. The computer program product of claim 18, wherein the one or more aspects are matched based on similar hyperparameters and similar taxonomy category.
